(19) United States
(12) Patent Application Publication
(10) Pub. No.: US 2003/0212473 A1
(43) Pub. Date: Nov. 13, 2003

(54) Processing system for a power distribution system

(75) Inventor: John S. Vandevanter, East Granby, CT (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: General Electric Company

(21) Appl. No.: 10/373,573

(22) Filed: Feb. 25, 2003

Related U.S. Application Data
(60) Provisional application No. 60/359,544, filed on Feb. 25, 2002.
(60) Provisional application No. 60/438,159, filed on Jan. 6, 2003.

(51) Int. Cl. H02H 3/20

(52) U.S. Cl. 700/293; 361/91.1

(57) ABSTRACT

There is provided a processing system for a power distribution system. The processing system includes a first processor for executing a first task having a first priority, and a second processor for executing a second task having a second priority.

### CROSS REFERENCE TO RELATED APPLICATIONS

The present application is claiming priority of U.S. Patent Application No. 60/359,544 filed on Feb. 25, 2002 for “Integrated Protection, Monitoring, and Control” the contents of which are incorporated by reference herein. The present application is also claiming priority of U.S. Patent Application No. 60/438,159 filed on Jan. 6, 2003 for “Single Processor Concept for Protection and Control of Circuit Breakers in Low-Voltage Switchgear” the contents of which are incorporated by reference herein.

### BACKGROUND OF THE INVENTION

1. Field of the Invention

The present invention relates to a power distribution system, and more particularly, to a processing system that is advantageously configured to handle processing requirements in a power distribution system. The arrangement is well suited for employment a centrally controlled circuit breaker protection system for the power distribution system.

2. Description of the Related Art

Industrial power distribution systems commonly divide incoming power into a number of branch circuits, where the branch circuits supply power to various equipment (i.e., loads) in an industrial facility. Circuit breakers are provided in each branch circuit to facilitate protection of equipment within the branch circuit. The circuit breakers can be opened or closed by non-automatic means, and can also be opened automatically when subjected to a predetermined over-current. Since this automatic protection is based on conditions of the power (e.g., current), suppliers of circuit breakers have commonly made a large range circuit breakers to meet the various current demands.

The present inventor has developed a unique centralized circuit breaker protection system having a processing apparatus that is capable of performing a combination of low priority tasks and high priority tasks in a timely manner, to ensure adequate protection of devices and personnel that the system is intended to protect.

### SUMMARY OF THE INVENTION

A centralized circuit breaker protection system controls and monitors circuit breakers in a power distribution system from a central control processing unit. In a centralized circuit breaker protection system, tasks executed by a processing apparatus are generally categorized as being of a high priority or a low priority. Events occurring during a startup of a power distribution system, and in particular during the first several milliseconds, if not properly controlled, may present a safety concern.

One embodiment of the present invention is a processing system for a power distribution system. The processing system includes a first processor for executing a first task having a first priority, and a second processor for executing a second task having a second priority.

Another embodiment of the present invention is a system including a first processor for executing an instantaneous overcurrent trip determination for a centralized circuit breaker protection system for a power distribution system, and a second processor for executing a task other than the instantaneous overcurrent trip determination.

### BRIEF DESCRIPTION OF THE DRAWINGS

FIG. 1 is a schematic of a power distribution system having an exemplary embodiment of a integrated protection, monitoring, and control system.

FIG. 2 is a schematic of an exemplary embodiment of a data sample and transmission module of the integrated protection, monitoring, and control system of FIG. 1.

FIG. 3 is a block diagram of a portion of the protection system of FIG. 1, with particular attention given to the central control processing unit.

FIG. 4 is a block diagram showing further details of a portion of the central control processing unit.

### DESCRIPTION OF THE INVENTION

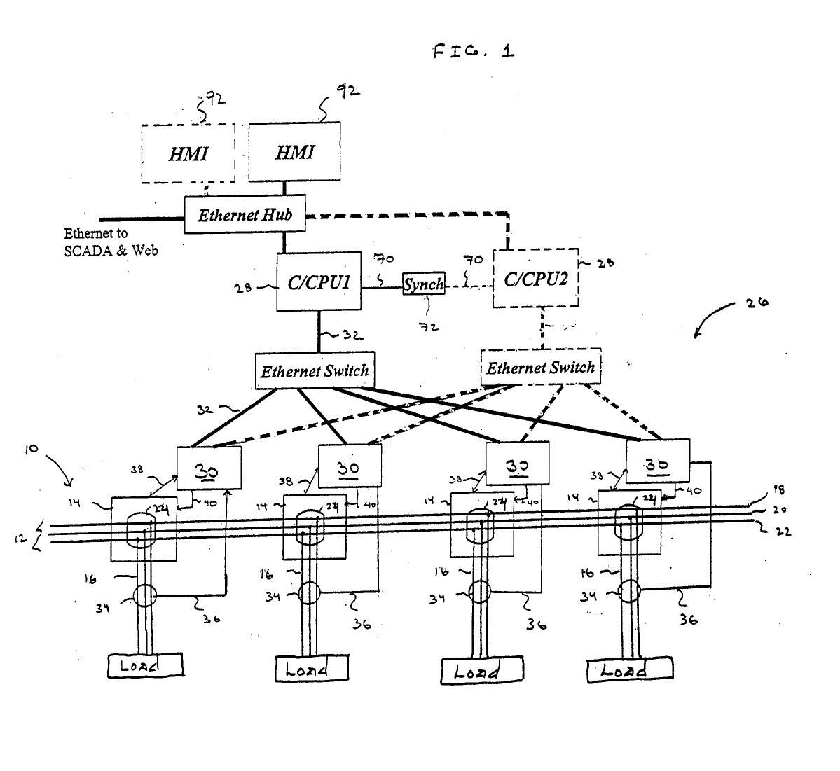

Referring now to the drawings and in particular to FIG. 1, an exemplary embodiment of a power distribution system generally referred to by reference numeral 10 is illustrated. System 10 distributes power from at least one power bus 12 through a number or plurality of circuit breakers 14 to branch circuits 16.

Power bus 12 is illustrated by way of example as a three-phase power system having a first phase 18, a second phase 20, and a third phase 22. Power bus 12 can also include a neutral phase (not shown). System 10 is illustrated for purposes of clarity distributing power from power bus 12 to four circuits 16 by four breakers 14. Of course, it is contemplated by the present disclosure for power bus 12 to have any desired number of phases and/or for system 10 to have any desired number of circuit breakers 14.

Each circuit breaker 14 has a set of separable contacts 24 (illustrated schematically). Contacts 24 selectively place power bus 12 in communication with at least one load (also illustrated schematically) on circuit 16. The load can include devices, such as, but not limited to, motors, welding machinery, computers, heaters, lighting, and/or other electrical equipment.

Power distribution system 10 is illustrated in FIG. 1 with an exemplary embodiment of a centrally controlled and fully integrated protection, monitoring, and control protection system 26 (hereinafter “protection system 26”). Protection system 26 is configured to control and monitor power distribution system 10 from a central control processing unit 28 (hereinafter “CCPU 28”). CCPU 28 communicates with a number or plurality of data sample and transmission modules 30 (hereinafter “module 30”) over a data network 32. Network 32 communicates all of the information from all of the modules 30 substantially simultaneously to CCPU 28.

Thus, protection system 26 can include protection and control schemes that consider the value of electrical signals, such as current magnitude and phase, at one or all circuit breakers 14. Further, protection system 26 integrates the protection, control, and monitoring functions of the individual breakers 14 of power distribution system 10 in a single, centralized control processor (e.g., CCPU 28). Protection system 26 provides CCPU 28 with all of a synchronized set of information available through digital communication with modules 30 and circuit breakers 14 on network 32 and provides the CCPU with the ability to operate these devices based on this complete set of data.

Specifically, CCPU 28 performs all primary power distribution functions for power distribution system 10. Namely, CCPU 28 performs all instantaneous overcurrent protection (IOC), short time overcurrent, longtime overcurrent, relay protection, and logic control as well as digital signal processing functions of protection system 26. Thus, protection system 26 enables settings to be changed and data to be logged in a single, central location, i.e., CCPU 28. CCPU 28 is described herein by way of example as a central processing unit. Of course, it is contemplated by the present disclosure for CCPU 28 to include any programmable circuit, such as, but not limited to, computers, processors, microcontrollers, microcomputers, programmable logic controllers, application specific integrated circuits, and other programmable circuits.

As shown in FIG. 1, each module 30 is in communication with one of the circuit breakers 14. Each module 30 is also in communication with at least one sensor 34 sensing a condition of the power in each phase (e.g., first phase 18, second phase 20, third phase 22, and neutral) of bus 12 and/or circuit 16. Sensors 34 can include current transformers (CTs), potential transformers (PTs), and any combination thereof. Sensors 34 monitor a condition of the incoming power in circuits 16 and provide a first signal 36 representative of the condition of the power to module 30. For example, sensors 34 can be current transformers that generate a secondary current proportional to the current in circuit 16 so that first signals 36 are the secondary current.

Module 30 sends and receives one or more second signals 38 to and/or from circuit breaker 14. Second signals 38 can be representative of one or more conditions of breaker 14, such as, but not limited to, a position of separable contacts 24, a spring charge switch status, and others. In addition, module 30 is configured to operate circuit breaker 14 by sending one or more third signals 40 to the breaker to open/close separable contacts 24 as desired. In a first embodiment, circuit breakers 14 cannot open separable contacts 24 unless instructed to do so by protection system 26.

Protection system 26 utilizes data network 32 for data acquisition from modules 30 and data communication to the modules. Accordingly, network 32 is configured to provide a desired level of communication capacity and traffic management between CCPU 28 and modules 30. In an exemplary embodiment, network 32 can be configured to not enable communication between modules 30 (i.e., no module-to-module communication).

In addition, protection system 26 can be configured to provide a consistent fault response time. As used herein, the fault response time of protection system 26 is defined as the time between when a fault condition occurs and the time module 30 issues a trip command to its associated breaker 14. In an exemplary embodiment, protection system 26 has a fault response time that is less than a single cycle of the 60 Hz (hertz) waveform. For example, protection system 26 can have a maximum fault response time of about three milliseconds.

The configuration and operational protocols of network 32 are configured to provide the aforementioned communication capacity and response time. For example, network 32 can be an Ethernet network having a star topology as illustrated in FIG. 1. In this embodiment, network 32 is a full duplex network having the collision-detection multiple-access (CSMA/CD) protocols typically employed by Ethernet networks removed and/or disabled. Rather, network 32 is a switched Ethernet for managing collision domains.

In this configuration, network 32 provides a data transfer rate of at least about 100 Mbps (megabits per second). For example, the data transfer rate can be about 1 Gbps (gigabits per second). Additionally, communication between CCPU 28 and modules 30 across network 32 can be managed to optimize the use of network 32. For example, network 32 can be optimized by adjusting one or more of a message size, a message frequency, a message content, and/or a network speed.

Accordingly, network 32 provides for a response time that includes scheduled communications, a fixed message length, full-duplex operating mode, and a switch to prevent collisions so that all messages are moved to memory in CCPU 28 before the next set of messages is scheduled to arrive. Thus, protection system 26 can perform the desired control, monitoring, and protection functions in a central location and manner.

It should be recognized that data network 32 is described above by way of example only as an Ethernet network having a particular configuration, topography, and data transmission protocols. Of course, the present disclosure contemplates the use of any data transmission network that ensures the desired data capacity and consistent fault response time necessary to perform the desired range of functionality. The exemplary embodiment achieves sub-cycle transmission times between CCPU 28 and modules 30 and full sample data to perform all power distribution functions for multiple modules with the accuracy and speed associated with traditional devices.

CCPU 28 can perform branch circuit protection, zone protection, and relay protection interdependently because all of the system information is in one central location, namely at CCPU 28. In addition, CCPU 28 can perform one or more monitoring functions on the centrally located system information. Accordingly, protection system 26 provides a coherent and integrated protection, control, and monitoring methodology not considered by prior systems. For example, protection system 26 integrates and coordinates load management, feed management, system monitoring, and other system protection functions in a low cost and easy to install system.

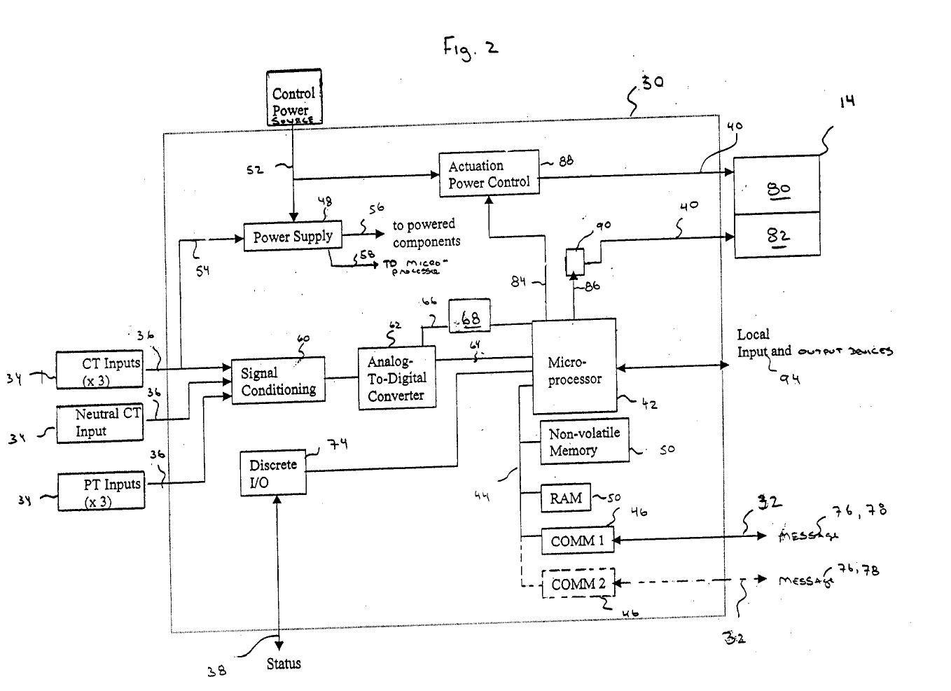

An exemplary embodiment of module 30 is illustrated in FIG. 2. Module 30 has a microprocessor 42, a data bus 44, a network interface 46, a power supply 48, and one or more memory devices 50.

Power supply 48 is configured to receive power from a first source 52 and/or a second source 54. First source 52 can be one or more of an uninterruptible power supply (not shown), a plurality of batteries (not shown), a power bus (not shown), and other sources. In the illustrated embodiment, second source 54 is the secondary current available from sensors 34.

Power supply 48 is configured to provide power 56 to module 30 from first and second sources 52, 54. For example, power supply 48 can provide power 56 to microprocessor 42, data bus 42, network interface 44, and memory devices 50. Power supply 48 is also configured to provide a fourth signal 58 to microprocessor 42. Fourth signal 58 is indicative of what sources are supplying power to power supply 48. For example, fourth signal 58 can indicate whether power supply 48 is receiving power from first source 52, second source 54, or both of the first and second sources.

Network interface 46 and memory devices 50 communicate with microprocessor 42 over data bus 44. Network interface 46 can be connected to network 32 so that microprocessor 42 is in communication with CCPU 28.

Microprocessor 42 receives digital representations of first signals 36 and second signals 38. First signals 36 are continuous analog data collected by sensors 34, while second signals 38 are discrete analog data from breaker 14. Thus, the data sent from modules 30 to CCPU 28 is a digital representation of the actual voltages, currents, and device status. For example, first signals 36 can be analog signals indicative of the current and/or voltage in circuit 16.

Accordingly, protection system 26 provides the actual raw parametric or discrete electrical data (i.e., first signals 36) and device physical status (i.e., second signal 38) to CCPU 28 via network 32, rather than processed summary information sampled, created, and stored by devices such as trip units, meters, or relays. As a result, CCPU 28 has complete, raw system-wide data with which to make decisions and can therefore operate any or all breakers 14 on network 32 based on information derived from as many modules 30 as the control and protection algorithms resident in CCPU 28 require.

Module 30 has a signal conditioner 60 and an analog-digital converter 62. First signals 36 are conditioned by signal conditioner 60 and converted to digital signals 64 by A/D converter 62. Thus, module 30 collects first signals 36 and presents digital signals 64, representative of the raw data in the first signals, to microprocessor 42. For example, signal conditioner 60 can includes a filtering circuit (not shown) to improve a signal-to-noise ratio first signal 36, a gain circuit (not shown) to amplify the first signal, a level adjustment circuit (not shown) to shift the first signal to a predetermined range, an impedance match circuit (not shown) to facilitate transfer of the first signal to A/D converter 62, and any combination thereof. Further, A/D converter 62 can be a sample-and-hold converter with external conversion start signal 66 from microprocessor 42 or a clock circuit 68 controlled by microprocessor 42 to facilitate synchronization of digital signals 64.

It is desired for digital signals 64 from all of the modules 30 in protection system 26 to be collected at substantially the same time. Specifically, it is desired for digital signals 64 from all of the modules 30 in protection system 26 to be representative of substantially the same time instance of the power in power distribution system 10.

Modules 30 sample digital signals 64 based, at least in part, upon a synchronization signal or instruction 70 as illustrated in FIG. 1. Synchronization instruction 70 can be generated from a synchronizing clock 72 that is internal or external to CCPU 28. Synchronization instruction 70 is simultaneously communicated from CCPU 28 to modules 30 over network 32. Synchronizing clock 72 sends synchronization instructions 70 at regular intervals to CCPU 28, which forwards the instructions to all modules 30 on network 32.

Modules 30 use synchronization instruction 70 to modify a resident sampling protocol. For example, each module 30 can have a synchronization algorithm resident on microprocessor 42. The synchronization algorithm resident on microprocessor 42 can be a software phase-lock-loop algorithm. The software phase-lock-loop algorithm adjusts the sample period of module 30 based, in part, on synchronization instructions 70 from CCPU 28. Thus, CCPU 28 and modules 30 work together in protection system 26 to ensure that the sampling (i.e., digital signals 64) from all of the modules in the system are synchronized.

Accordingly, protection system 26 is configured to collect digital signals 64 from modules 30 based in part on synchronization instruction 70 so that the digital signals are representative of the same time instance, such as being within a predetermined time-window from one another. Thus, CCPU 28 can have a set of accurate data representative of the state of each monitored location (e.g., modules 30) within the power distribution system 10. The predetermined time-window can be less than about ten microseconds. For example, the predetermined time-window can be about five microseconds.

The predetermined time-window of protection system 26 can be affected by the port-to-port variability of network 32. In an exemplary embodiment, network 32 has a port-to-port variability of in a range of about 24 nanoseconds to about 720 nanoseconds. In an alternate exemplary embodiment, network 32 has a maximum port-to-port variability of about 2 microseconds.

It has been determined that control of all of modules 30 to this predetermined time-window by protection system 26 enables a desired level of accuracy in the metering and vector functions across the modules, system waveform capture with coordinated data, accurate event logs, and other features. In an exemplary embodiment, the desired level of accuracy is equal to the accuracy and speed of traditional devices. For example, the predetermined time-window of about ten microseconds provides an accuracy of about 99% in metering and vector functions.

Second signals 38 from each circuit breaker 14 to each module 30 are indicative of one or more conditions of the circuit breaker. Second signals 38 are provided to a discrete I/O circuit 74 of module 30. Circuit 74 is in communication with circuit breaker 14 and microprocessor 42. Circuit 74 is configured to ensure that second signals 38 from circuit breaker 14 are provided to microprocessor 42 at a desired voltage and without jitter. For example, circuit 74 can include de-bounce circuitry and a plurality of comparators.

Microprocessor 42 samples first and second signals 36, 38 as synchronized by CCPU 28. Then, converter 62 converts the first and second signals 36, 38 to digital signals 64, which is packaged into a first message 76 having a desired configuration by microprocessor 42. First message 76 can include an indicator that indicates which synchronization signal 70 the first message was in response to. Thus, the indicator of which synchronization signal 70 first message 76 is responding to is returned to CCPU 28 for sample time identification.

CCPU 28 receives first message 76 from each of the modules 30 over network 32 and executes one or more protection and/or monitoring algorithms on the data sent in all of the first messages. Based on first message 76 from one or more modules 30, CCPU 28 can control the operation of one or more circuit breakers 14. For example, when CCPU 28 detects a fault from one or more of first messages 76, the CCPU sends a second message 78 to one or more modules 30 via network 32.

In response to second message 78, microprocessor 42 causes third signal 40 to operate (e.g., open contacts 24) circuit breaker 14. Circuit breaker 14 can include more than one operation mechanism. For example, circuit breaker 14 can have a shunt trip 80 and a magnetically held solenoid 82. Microprocessor 42 is configured to send a first output 84 to operate shunt trip 80 and/or a second output 86 to operate solenoid 82. First output 84 instructs a power control module 88 to provide third signal 40 (i.e., power) to shunt trip 80, which can separate contacts 24. Second output 86 instructs a gating circuit 90 to provide third signal 40 to solenoid 82 (i.e., flux shifter) to separate contacts 24. It should be noted that shunt trip 80 requires first source 52 to be present, while solenoid 82 can be operated only when second source 54 is present. In this manner, microprocessor 42 can operate circuit breaker 14 in response to second message 78 regardless of the state of first and second sources 52, 54.

In addition to operating circuit breaker 14, module 30 can communicate to one or more local input and/or output devices 94. For example, local output device 94 can be a module status indicator, such as a visual or audible indicator. In one embodiment, device 94 is a light emitting diode (LED) configured to communicate a status of module 30. In another embodiment, local input device 94 can be a status-modifying button for manually operating one or more portions of module 30. In yet another embodiment, local input device 94 is a module interface for locally communicating with module 30.

Accordingly, modules 30 are adapted to sample first signals 36 from sensors 34 as synchronized by the CCPU. Modules 30 then package the digital representations (i.e., digital signals 64) of first and second signals 36, 38, as well as other information, as required into first message 76. First message 76 from all modules 30 are sent to CCPU 28 via network 32. CCPU 28 processes first message 76 and generates and stores instructions to control the operation of each circuit breaker 14 in second message 78. CCPU 28 sends second message 78 to all of the modules 30. In an exemplary embodiment, CCPU 28 sends second message 78 to all of the modules 30 in response to synchronization instruction 70.

Accordingly, protection system 26 can control each circuit breaker 14 based on the information from that breaker alone, or in combination with the information from one or more of the other breakers in the protection system 26. Under normal operating conditions, protection system 26 performs all monitoring, protection, and control decisions at CCPU 28.

Since the protection and monitoring algorithms of protection system 26 are resident in CCPU 28, these algorithms can be enabled without requiring hardware or software changes in circuit breaker 14 or module 30. For example, protection system 26 can include a data entry device 92, such as a human-machine-interface (HMI), in communication with CCPU 28. In this embodiment, one or more attributes and functions of the protection and monitoring algorithms resident on CCPU 28 can easily be modified from data entry device 92. Thus, circuit breaker 14 and module 30 can be more standardized than was possible with the circuit breakers/trip units of prior systems. For example, over one hundred separate circuit breakers/trip units have been needed to provide a full range of sizes normally required for protection of a power distribution system. However, the generic nature of circuit breaker 14 and module 30 enabled by protection system 26 can reduce this number by over sixty percent. Thus, protection system 26 can resolve the inventory issues, retrofittability issues, design delay issues, installation delay issues, and cost issues of prior power distribution systems.

It should be recognized that protection system 26 is described above as having one CCPU 28 communication with modules 30 by way of a single network 32. However, it is contemplated by the present disclosure for protection system 26 to have redundant CCPUs 26 and networks 32 as illustrated in phantom in FIG. 1. For example, module 30 is illustrated in FIG. 2 having two network interfaces 46. Each interface 46 is configured to operatively connect module 30 to a separate CCPU 28 via a separate data network 32. In this manner, protection system 26 would remain operative even in case of a failure in one of the redundant systems.

Modules 30 can further include one or more backup systems for controlling breakers 14 independent of CCPU 28. For example, protection system 26 may be unable to protect circuit 16 in case of a power outage in first source 52, during the initial startup of CCPU 28, in case of a failure of network 32, and other reasons. Under these failure conditions, each module 30 includes one or more backup systems to ensure that at least some protection is provided to circuit breaker 14. The backup system can include one or more of an analog circuit driven by second source 54, a separate microprocessor driven by second source 54, and others.

Tasks performed by CCPU 28 are generally categorized as being of a high priority or a low priority. CCPU 28 includes a first processor for executing high priority tasks in protection system 26, and second processor for executing lower priority tasks in protection system 26.

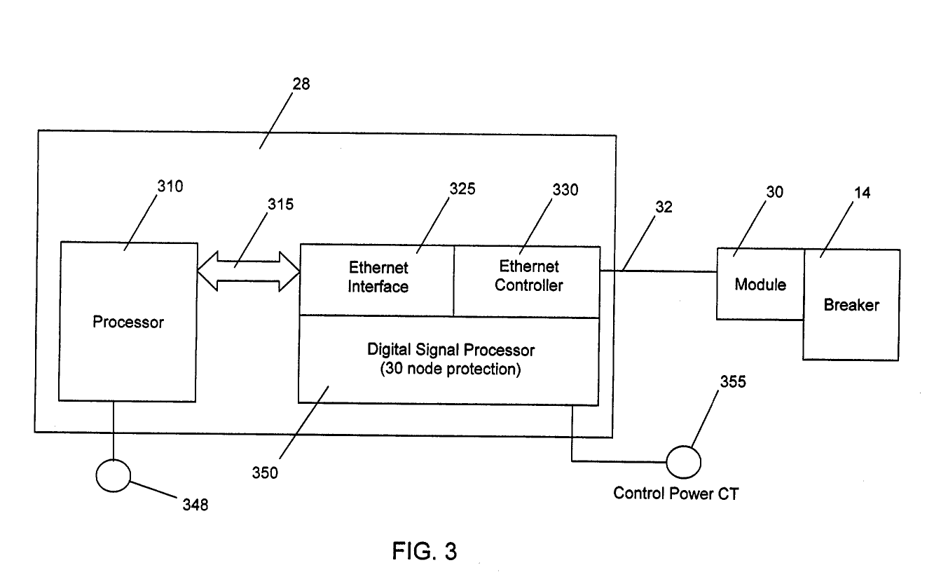

FIG. 3 is a block diagram of a portion of protection system 26, with particular attention given to CCPU 28. CCPU 28 includes a processor 310 and a processor 350. CCPU 28 also includes an Ethernet controller 330, an Ethernet interface 325 and a bus 315. CCPU 28 communicates with modules 30 via network 32.

Ethernet controller 330 manages transmission and receipt of Ethernet data packets between CCPU 28 and network 32.

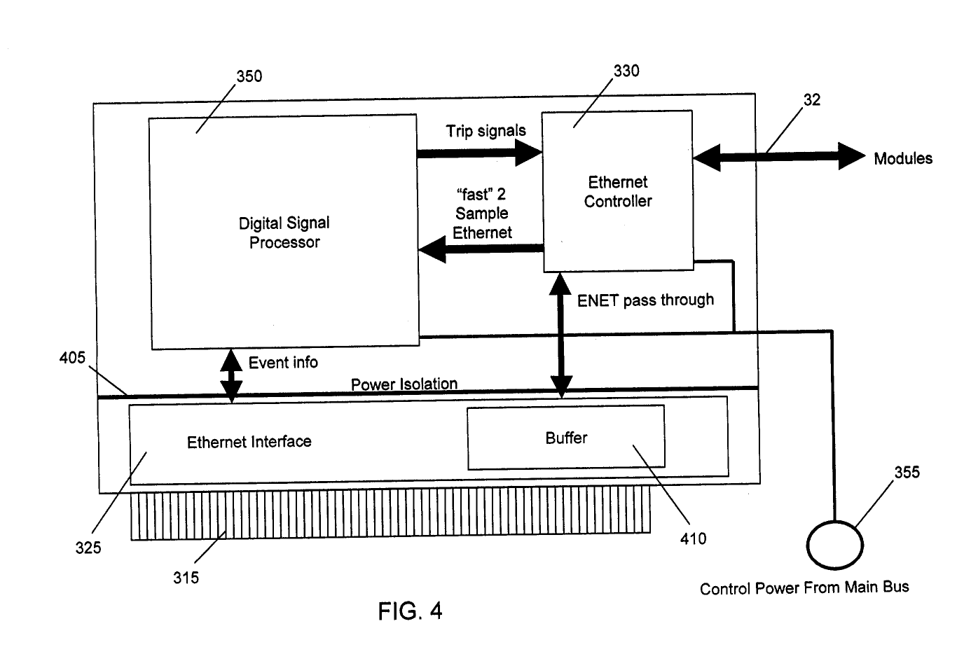

Ethernet interface 325 manages Ethernet traffic between processor 310 and processor 350, and between processor 310 and Ethernet controller 330. Ethernet interface 325 is described in greater detail below, in association with FIG. 4.

Bus 315 couples processor 310 to Ethernet interface 325 for communication therebetween. Generally, bus 315 can be any bus for such communication. A peripheral component interconnect (PCI) is an example of a suitable embodiment of bus 315.

Although CCPU 28 is illustrated herein as having each of processors 310 and 350, Ethernet interface 325 and Ethernet controller 330 in a single structure, such an arrangement is not intended as the only possible configuration of CCPU 28. Instead, CCPU 28 can be a distributed system, where each of the components of CCPU 28 can be remotely located from one another. For example, bus 315 could be part of a network separating processor 310 from the other components of CCPU 28. Accordingly, the present invention does not require processor 310, processor 350, Ethernet interface 325 and Ethernet controller 330 to have any particular spatial proximity to one another.

Processor 310 is for executing lower priority tasks. Lower priority tasks include functions that are not as time critical as higher priority tasks. These lower priority tasks may include, but are not limited to relaying, waveform capture, sequence of events logging and general human-machine interface functions. Processor 310 is implemented on a general-purpose microcomputer, and as such, it includes a central processing unit (not shown) and a memory (not shown) for storing data and instructions for execution by the central processing unit.

Processor 350 is for executing higher priority tasks. Examples of higher priority tasks include real-time processing tasks, such as, an instantaneous overcurrent trip determination, a short time overcurrent trip determination, a long time overcurrent trip determination, and a ground fault trip determination. In order to ensure that processor 350 is capable of real-time processing, processor 350 is contemplated as being a digital signal processor, optimized to perform mathematical operations on a digitized signal. However, processor 350 may also be implemented on a general-purpose microcomputer, provided that such microcomputer is fast enough to meet the real-time processing demands.

Consider the task of an instantaneous overcurrent trip determination. Processor 350 receives data via Ethernet controller 330 from module 30 relating to current flow through breaker 14. In this case, being fast enough to meet real-time processing demands means that processor 350 receives data relating to an occurrence of an instantaneous overcurrent event, and makes a protective determination with regard to the event within a predetermined acceptable period of time of the receipt of the data. The protective determination may be, for example, recognition of an instantaneous overcurrent condition, and an issuance of a command for module 30 to open breaker 14. A realistic target for processor 350 to be considered fast enough is that it renders the protective determination within 4 milliseconds (ms) of its receipt of the data.

Generally, processor 350 is intended for executing tasks relating to an evaluation of critical parameters in protection system 26. As mentioned above, these tasks include an instantaneous overcurrent trip determination, a short time overcurrent trip determination, a long time overcurrent trip determination, and a ground fault trip determination. By executing these tasks with processor 350, CCPU 28 provides primary overcurrent protection functionality for the plurality of breakers 14 in power distribution system 10.

Processor 350 receives power from a power source 355. Power source 355 is directly, or closely, associated with a feed line of power distribution system 10 that is also feeding breaker 14. For example, in the embodiment of FIG. 3, power source 355 is from a control power current transformer. By receiving power from power source 355, processor 350 will be up and running when power is available from power source 355. An advantage of having processor 350 powered from power source 355 is described below in association with FIG. 4.

Processor 310 can be powered from the same power source as processor 350, or it can be powered by a different power source. In FIG. 3, processor 310 is shown as being powered by a power source 348, which is not the same as power source 355.

FIG. 4 is a block diagram showing further details of a portion of CCPU 28. The embodiment of the portion of CCPU 28 shown in FIG. 4 corresponds to the arrangement in FIG. 3 where processor 350 and processor 310 are being powered from two separate power sources. Note that CCPU 28 includes an interface 405, and that Ethernet interface 325 includes a buffer 410. Interface 405 and buffer 410 are described below in greater detail.

As, mentioned above, power source 355 is directly, or closely, associated with a feed line of power distribution system 10. Processor 350 and Ethernet controller 330 receive power from power source 355, e.g., a feed line. In a situation where the feed line goes down, such as in a case of a storm, and is restored sometime thereafter, processor 350 and Ethernet controller 330 will be up and running a short time after restoration of power at power source 355. Processor 350 is contemplated as being ready to execute its tasks within 4 ms of when power is provided from power source 355. Thus, in a case of a re-initialization or fast wakeup, processor 350 will be up and running, and providing real-time protective capability for protection system 26, within 4 ms.

Interface 405 is a communication interface for coupling signals, e.g., event information, between processor 350 and Ethernet interface 325, and couples signals, i.e., Ethernet data packets, between Ethernet controller 330 and Ethernet interface 325. Interface 405 also provides power isolation between power source 355 and power source 348. Interface 405 achieves the power isolation by optically coupling the signals. As mentioned above in the discussion of FIG. 3, CCPU 28 can be a distributed system. As such, interface 405 can be an optical network link.

CCPU 28 manages modules 30, which in turn control breakers 14. Power distribution system 10 may include a plurality of breakers 14, and thus, CCPU 28 may manage a plurality of modules 30. As CCPU 28 makes determinations relating to a plurality of breakers 14, CCPU 28 may be regarded as a poly-noded trip unit. Assume, for example, that CCPU 28 is managing thirty modules 30, and so, CCPU 28 communicates with the thirty modules 30 via network 32.

Each of modules 30 regularly send data relating to the operation of breakers 14 in an Ethernet data packet. Assume that each module 30 sends such a packet every 520 microseconds (μs). In the case of thirty modules 30, Ethernet controller 330 receives thirty data packets in 520 μs, which is, on average, one data packet approximately every 17.3 μs, i.e., 17.3 μs 520 μs/30. When Ethernet controller 330 receives a data packet, it issues an interrupt to processor 350 and Ethernet interface 325.

Processor 350 handles the interrupt as soon as possible, that is, with a high priority. For example, for a data packet containing a fast two-sample reading of current through breaker 14, processor 350 reads the data packet and makes a determination as to whether a protective action, e.g., a trip signal for breaker 14, is necessary.

Ethernet interface 325 also responds to the interrupt as soon as possible, and stores the data packet into buffer 410. Processor 310 eventually reads the data packets from buffer 410. However, recall that processor 310 is responsible for executing lower priority tasks. As such, processor 310 does not necessarily read the data packets from buffer 410 with immediacy. Processor 310 is relieved from having to handle an interrupt for each data packet, either by having buffer 410 issue an interrupt to processor 310 only at some predetermined, relatively low, rate, or by having processor 310 read buffer 410 at some periodic interval of time. In any case, processor 310 reads the data packets from buffer 410 as a batch. By reading the data packets as a batch, rather than having to respond to an interrupt for each individual data packet, processor 310 can manage its various processes in a more efficient manner. That is, because processor 310 is responsible only for lower priority tasks, it is relieved of an unnecessary burden of urgently handling individual interrupts.

It should be understood that various alternatives and modifications of the present invention could be devised by those skilled in the art. Nevertheless, the present invention is intended to embrace all such alternatives, modifications and variances that fall within the scope of the appended claims.

What is claimed is:

1. A processing system for a power distribution system, comprising:
a first processor for executing a first task having a first priority; and
a second processor for executing a second task having a second priority.

2. The processing system of claim 1, wherein said processing system is a component of a centralized circuit breaker protection system for said power distribution system.

3. The processing system of claim 1, wherein said first processor comprises a digital signal processor.

4. The processing system of claim 1, wherein said first task is selected from the group consisting of: an instantaneous overcurrent trip determination, a short time overcurrent trip determination, a long time overcurrent trip determination, and a ground fault trip determination.

5. The processing system of claim 1, wherein said first processor makes a protective determination with regard to an event within 4 milliseconds of a receipt of data relating to an occurrence of said event.

6. The processing system of claim 1, wherein said first processor is ready to execute said first task within 4 milliseconds of when power is provided to said first processor.

7. The processing system of claim 1, wherein said first processor is powered by a power feed of said power distribution system, and wherein said power feed is also feeding a breaker that is controlled by said processing system.

8. The processing system of claim 1, wherein said first processor is powered by a first power source and said second processor is powered by a second power source.

9. The processing system of claim 8, further comprising a communication interface between said first processor and said second processor that provides power isolation between said first power source and said second power source.

10. The processing system of claim 9, wherein said power isolation is achieved by optically coupling signals through said communication interface.

11. The processing system of claim 1, further comprising:
a buffer for storing a plurality of data packets from a data communication network,
wherein said second processor reads said plurality of data packets from said buffer as a batch.

12. A processing system for a centralized circuit breaker protection system for a power distribution system, comprising:
a first processor for executing an instantaneous overcurrent trip determination for said centralized circuit breaker protection system; and
a second processor for executing a task other than said instantaneous overcurrent trip determination.

13. The processing system of claim 12, wherein said first processor also executes a task selected from the group consisting of: a short time overcurrent trip determination, a long time overcurrent trip determination, and a ground fault trip determination.

14. The processing system of claim 12, wherein said first processor makes said instantaneous overcurrent trip determination within 4 milliseconds of a receipt of data relating to an occurrence of an instantaneous overcurrent condition.

15. The processing system of claim 12, wherein said first processor is ready to execute said first task within 4 milliseconds of when power is provided to said first processor.

16. The processing system of claim 12,
wherein said first processor is powered by a power feed of said power distribution system, and
wherein said power feed is also feeding a breaker that is controlled by said processing system.

17. The processing system of claim 12, wherein said first processor is powered by a first power source and said second processor is powered by a second power source.

18. The processing system of claim 17, further comprising a communication interface between said first processor and said second processor that provides power isolation between said first power source and said second power source.

19. The processing system of claim 12, further comprising:
a buffer for storing a plurality of data packets from a data communication network,
wherein said second processor reads said plurality of data packets from said buffer as a batch.

20. A method of executing tasks in a power distribution system, comprising:
employing a first processor for executing a first task having a first priority; and
employing a second processor for executing a second task having a second priority.

21. The method of claim 20, wherein said first processor and said second processor are components in a centralized circuit breaker protection system for said power distribution system.

22. A method for executing tasks in a centralized circuit breaker protection system for a power distribution system, comprising:
employing a first processor for executing an instantaneous overcurrent trip determination for said centralized circuit breaker protection system; and
employing a second processor for executing a task other than said instantaneous overcurrent trip determination.
